(19) United States
(12) Patent Application Publication
(10) Pub. No.: US 2013/0110808 A1
(43) Pub. Date: May 2, 2013

(54) EVENT MEMORABILIA

(71) Applicants: Jordan Naftolin, Seattle, WA (US); Patrick Derks, Seattle, WA (US)

(72) Inventors: Jordan Naftolin, Seattle, WA (US); Patrick Derks, Seattle, WA (US)

(73) Assignee: MICROSOFT CORPORATION, Redmond, WA (US)

(21) Appl. No.: 13/281,910

(22) Filed: Oct. 26, 2011

(51) Int. Cl. G06F 17/30

(52) U.S. Cl. 707/707; 707/785; 707/E17.108; 707/E17.059

(57) ABSTRACT

A method for storing event memorabilia is provided by an online service that receives over a wide-area network notification that a first user has registered to attend an event a sporting event, a concert). The service also receives over the wide-area network metadata associated with the event. The service locates a user profile associated with the first user and stores the metadata and an association between the metadata and the first user profile in a database. The service also grants the first user access to the user profile and the metadata associated therewith.

### BACKGROUND

People attend a wide variety of events over the course of their life. For instance, spectator events such as sporting events, entertainment events (e.g., concerts, theatre, films) and the like have become a multibillion dollar a year business throughout the world. As one example, millions of people attend their favorite sporting events, choosing among baseball, soccer, basketball, hockey, football, tennis, golf, auto racing, horse racing, boxing, and many others. Rather than merely watching sporting events on television, fans are willing to pay for the privilege of attending such events live in order to enjoy the spontaneity and excitement.

Some of the events people attend may have nostalgic importance. For this reason people often retain and collect memorabilia of events. Some people even keep a physical box or other container in which they store such memorabilia such as a ticket stub to a particularly memorable sporting event, concert, theatrical event and the like. However, physical ticket stubs and the like have limitations that make them less than ideal as items of memorabilia.

Some of the limitations of physical tickets are the following. Physical tickets fade over time, take up space, and are easily lost. Physical tickets do not provide any additional context to the event (e.g. pictures, final score, concert set lists, etc.), are not easily searchable and are not conveniently shared with friends. As tickets to events are more commonly being issued digitally, there is no easy way to retain them for nostalgic purposes.

### SUMMARY

in one implementation, a cloud-based service is provided which can store collections of event memorabilia associated with events a user has attended. The event memorabilia may include details about the event provided by the user such as images and notes as well as information made available directly to the service by one or more parties associated with the event. The service may automatically obtain the information from the parties once the user has indicated, to the service that it is an event the user has or will attend. The service maintains the information it has obtained from the user and from other sources as metadata that it associates with a user profile that has been established for the user. The user can search or browse the metadata to locate information about previously attended events, as can other users authorized by the user. In this way one user can locate other individuals who have or will attend an event or events that the user has attended or will attend. In some implementations, the service may obtain information about users from social networking sites to which the users belong. In this way users may share information about themselves with other users who have similar interests and who have attended the same or similar events.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows one example of a screen shot of a web page that may be presented to a user by an event memorabilia system.

FIG. 2 shows an example of a web page that may be presented by an event memorabilia system which allows users to establish their own personal profiles.

FIG. 3 shows an example of a web page that may be presented by an event memorabilia system which allows users to select from among different categories of recommendations that may be provided by the system to users.

FIG. 4 shows one example of an operating environment in which the processes for maintaining a history of events visited by attendees described herein may be implemented.

FIG. 5 shows one example an event memorabilia system.

FIG. 6 is a flowchart showing one example of a method for storing event memorabilia.

### DETAILED DESCRIPTION

At the outset it should be understood that the term “event” as used herein refers to a place or location at which an activity takes place. An event or activity generally takes place at a venue, which may include, by way of illustration, stadiums, theatres, museums, casinos, cruise ships, theme parks, agricultural fairs or similar expositions, trade shows, conventions, or the like.

The events or activities that take place in a venue may be associated with specific and defined programmatic content having an identifiable duration, such as the content provided by an athletic event, a musical or theatrical performance, or the like. On the other hand, attendees experience some events or activities while patronizing avenue such as a museum, casino, cruise ship, theme park, agricultural fair, trade show, convention, or the like, which may or may not include specific programmatic content having a generally defined duration as part or all of the activity. In some instances, the totality of activities has a duration bounded by opening and closing hours of a museum, park, fairgrounds, convention hall, or the like. In other forms of entertainment, e.g. at casinos, activity often continues around the clock. It is to be understood that the present invention relates to events and activities either with or without the foregoing specific programmatic content and defined duration.

As detailed below, a cloud-based service is provided which can store collections of event memorabilia associated with events a user has attended. The service can also automatically associate metadata with the events that are stored. For example, if the event is a sports events, the final scores and various statistics may be stored as metadata. Likewise, if the event is a concert, the metadata that is stored may include the set list or musical numbers. The metadata may be automatically obtained by the service from the venue at which the event is being held, a content provider associated with the venue, the event sponsor or the event producer, and so on. Often a pre-arranged contractual agreement may be in place between the service and the content provider in order for the service to obtain the metadata. In addition, the service may allow the user to optionally share and compare event memorabilia with other individuals, either through social networking services such as Facebook Xbox Live® or through the cloud-based service itself.

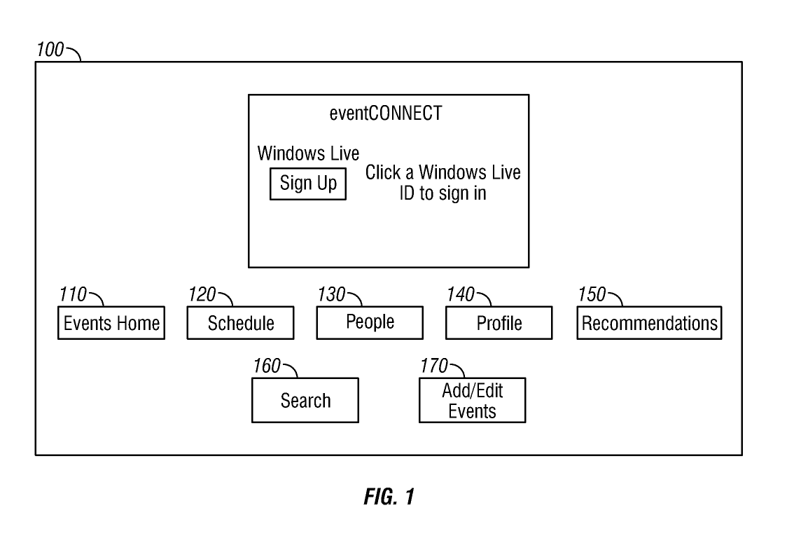

Event attendees and other users may login and logout of the service. FIG. 1 shows one example of a screen shot of a web page that may be presented to an attendee. The web page will generally be presented after the attendee has logged in to the system, either through the system administrator's web site, which in this example is the Windows Live™ web site operated by Microsoft. By logging in users may add, delete and edit their own account information and establish a personal profile while controlling who else may access such information. Examples of some of the capabilities mentioned above will be presented below.

The screen shot 100 shown in FIG. 1 presents a menu bar that includes a series of navigation tags 110, 120, 130, 140, 150, 160 and 170. In this example, as well as in others that follow, the conference networking service is illustratively associated with the Windows Live™ online service and is referred to as “eventCONNECT.” Selection of the navigation tags may bring up items such as an events view, a schedule view, a people view, a profile view, a recommendations view, a search view and an add/edit event view.

The events view 110 allows the user to browse his or her past events, search for an event they previously attended and view, add and edit event details. Users may also be able to associate images from the event and add additional notes and comments, which may provide details of the event as experienced by the user.

The schedule view 120 provides a list of upcoming events that a user is scheduled to attend in chronological order by date. The events may be presented in a fashion similar to a calendar application. When an event is clicked on, information about the event may cover, for example, a portion of the screen. Along with the name of the event, an addition piece of information that may be provided in the schedule includes, for example, a summary of the performer(s) and/or the content to be presented at the event.

If the user selects the people tag 130 in FIG. 1 a list of attendees organized by events the user has attended will be provided, possibly along with various items about the attendees that may be obtained, for instance, from their own respective profiles and/or social networking sites. The user may also be able to search for individual attendees that meet criteria of interest to the use. This may be accomplished by searching the profiles of the attendees. The user may also be provided with a link to the individual attendees that have been identified in order to send messages or otherwise establish communication with them by any appropriate means.

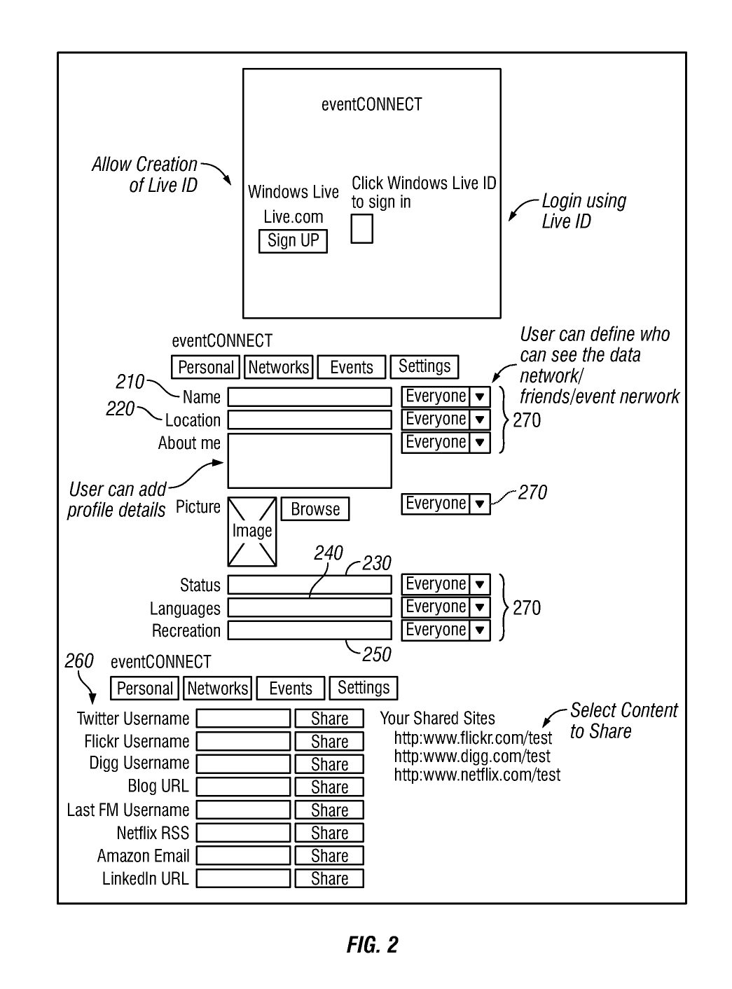

If the attendee selects the profile navigation tag 140 shown in FIG. 1, a web page may be presented that allows the user to establish his or her own personal profile. An example of a screen shot 200 of such a web page is shown in FIG. 2. The user constructs his or her personal profile by populating various fields 210, 220, 230, 240, 250 and 260 on the web page. For instance, in addition to such basic information as name, contact addresses, and the like, other fields may allow the attendee to specify recreational interests and so on. In addition, the user may enter one or more usernames that he or she uses on various social networking sites. Each username provides a link to the user's profile on a different social networking site. Examples of such sites include, without limitation, Facebook, Twitter, Flickr, Digg, Netflix, Amazon and Linkedin. By providing these usernames the user can share with other attendees additional information about him or herself that is available on the social networking sites. Such additional information may include friends and other individuals for which the user has provided links. The user profile that results from aggregating the profile created specifically for the event along with the profile or profiles available on the social networking site(s) can provide a rich set of information that may be made available to other users concerning common interests which may or may not directly revolve around the event that the user will or has attended.

Each field in the user's profile may be shared with all other attendees or only with various subsets of attendees by appropriate selection from a pulldown menu 270 associated with the various fields.

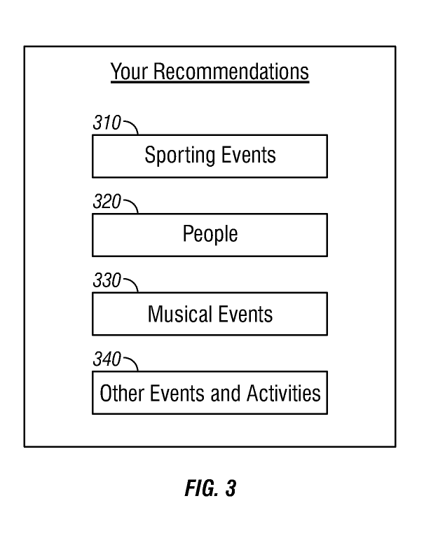

Once the attendee's profile is complete the data contained therein (including data contained in the attendee's social networking profile(s)) may serve as metadata or tags that can be searched by other attendees or used by the on-line system to make various recommendations of events and activities that may be of interest to the attendee. For instance, as shown in FIG. 3, by clicking on the recommendations tag 150 in FIG. 1 the user may select from among a variety of categories on a recommendations page. In this example the categories include upcoming sporting events 310, people (e.g., other attendees of upcoming events), 320, musical events (e.g., concerts) 330, and other events and activities (e.g., museum exhibitions) 340. By selecting one of the categories the user may view recommendations that have been tailored to his or her interests based on events the user has and/or will attend. The recommendations may also be tailored so that they do not conflict with other events that the user has already scheduled.

In some implementations the user may be able to subscribe to receive notifications (e.g., e-mails) about a recommended event or the performer, team, etc., participating in the event directly from the page of recommendations provided by the on-line system.

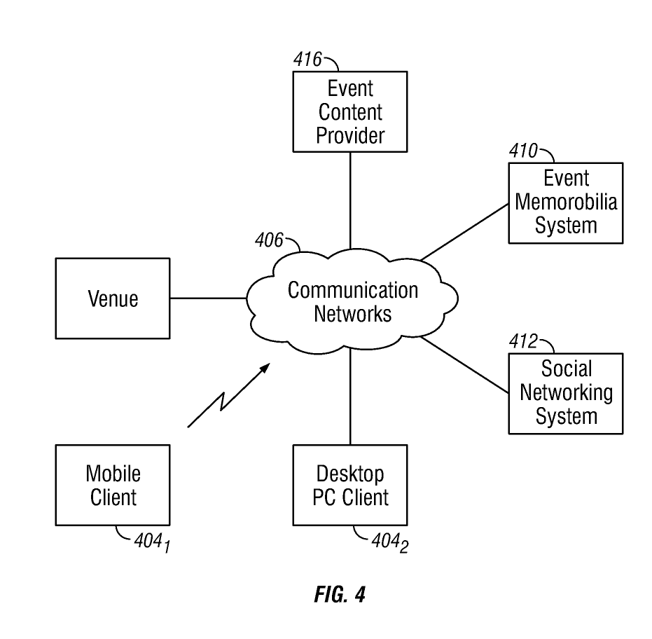

FIG. 4 shows one example of an operating environment 100 in which the processes for maintaining a history of events visited by attendees described herein may be implemented. The environment 100 includes one or more client devices that can communicate with one or more services via a network 406. Network 406 can be a variety of different networks, including the Internet, a local area network (LAN), a public telephone network, a cellular or other wireless phone network, an intranet, other public and/or proprietary networks, combinations thereof, and so forth.

Each client device 404 can be a variety of different types of devices. For example, a client device can be a desktop computer 402, a mobile communication device, an entertainment appliance, a set-top box communicatively coupled to a display device, a personal digital assistant (PDA), a game console, an automotive computer, and so forth. Thus, each client device can range from a full resource device with substantial memory and processor resources (e.g., personal computers, game consoles) to a low-resource device with limited memory and/or processing resources (e.g., traditional set-top boxes, hand-held game consoles), FIG. 4 shows two illustrative client devices 404, which in this example are mobile communication device 404₁ and desktop computer 404₂.

Client devices 404 receive services over network 406 that are provided by event memorabilia system 410. System 410 may include different types of computing devices such as one or more servers, for instance.

Operating environment 100 may also include one or more social networking systems 412, one or more venues 414 in which events are held and event content providers 416.

A user may use the event memorabilia system 410 to perform a wide variety of tasks, a few of which have been described above and are summarized below. The event memorabilia system 410 provides the client device with the web pages described above. Illustrative features that may be offered by the event memorabilia system 410 include the following.

1. The event memorabilia system 410 can maintain a history of the events users have attended.

2. Events may be automatically added to the user's history after a ticket or other proof of admission to the event has been purchased and can be linked to the user, which may occur when a ticket is purchased by phone or online, when a user enters the event and uses their client device for ticket redemption (e.g., via a near field communication device incorporated into the client device) or when the user checks in to the venue by other suitable means.

3. Users can manually enter events into the event memorabilia system if tickets have been purchased non-electronically and are thus unable to be automatically added to the user's history.

4. For each event in the user's history, the event memorabilia system would maintain event metadata (including, but not limited to, the final score and game highlights for a sports event, a set list for a concert, a cast list for a show, etc.). The event metadata can be provided to the event memorabilia system by the venue itself or by a content provider acting in cooperation with the venue, the event promoter and/or another third party.

5. The event memorabilia system may provide an interface through which the user can add notes, pictures and comments which are to be associated with the events included in their event history.

6. Users can browse, search or otherwise view their collection of events and associated metadata maintained by the event memorabilia system to reminisce and optionally share and compare their event collection with their friends.

7. The event memorabilia system can recommend other events the user may be interested in based on the previous events they attended and possibly the user profile. Such events can be identified in a variety of different ways, such as by using information and recommendations from other users who have attended similar events and information obtained from the content providers and the social networking sites.

8. The event memorabilia system may also offer various social networking capabilities including, by way of example:
i) Allowing a user to share the user's information such that a friend can browse his or her event collection;
ii) Allowing a first user to compare his or her events with events attended by other users so that the first user can identity events they have both attended;
iii) Allowing a user to tag friends who were at events that the user also attended so that the friends can be associated with the event, allowing the user to remember who else was at the event;
iv) Allowing users to rate the events they have attended and vote on their favorite events.

9. The event memorabilia system may reward loyal fans of a performer, team, etc., based on the number of events they attend for that performer, team, etc. For instance, if the system can confirm the number of events a user attends, typically by receiving notification that the user has registered for au event, the user can be given recognition for the achievement. For instance, a user may be recognized for attending all the home games of the Seahawks or attending all the performances by Coldplay on their North American tour. The recognition may take the form of an acknowledgment displayed on the user's profile, and in some cases may optionally include a reward such as a cash back rebate, reward points (which may be redeemed to purchase any of a variety of products and services associated with the performer or team), coupons, certificates and the like.

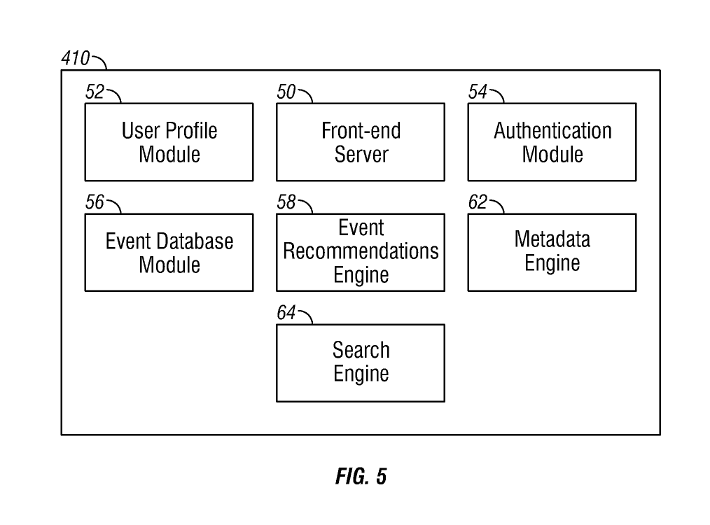

One example of the event memorabilia system 410 shown in FIG. 4 is shown in more detail in FIG. 5. The illustrative event memorabilia system 410 includes typically includes one or more physical server computers with one or more physical storage devices and/or databases as well as various processing engines. In the example of FIG. 5 the event memorabilia system 410 includes a front-end server 50 that executes one or more applications that provide the above-mentioned services to the clients. The front-end server 50 also establishes communication with and obtains information from social networking sites, content providers and the like. The event memorabilia system 410 also includes a user profile module 52, an authentication module 54, an event database module 56, an events recommendation engine 58, a metadata engine 62 and a search engine 64. The user profile module 52 acquires, stores and makes available for searching the user profiles. In addition, the user profile module 52 may also store the history of events and activities that the users have attended and scheduled. The authentication module 54 authorizes and authenticates the various users of the system, including event attendees and content providers. The event database module 56 acquires, stores and makes available for searching information concerning upcoming events. The events recommendations engine 58 generates recommendations using the information in the user profile module 52, event database module 56 and the metadata engine 62 and possibly information obtained from social networking sites. Metadata engine 62 acquires, stores and makes available for searching the metadata associated with various events. The search engine 64 responds to user requests by searching the user, the event database module 56 and the databases associated with the metadata engine 62.

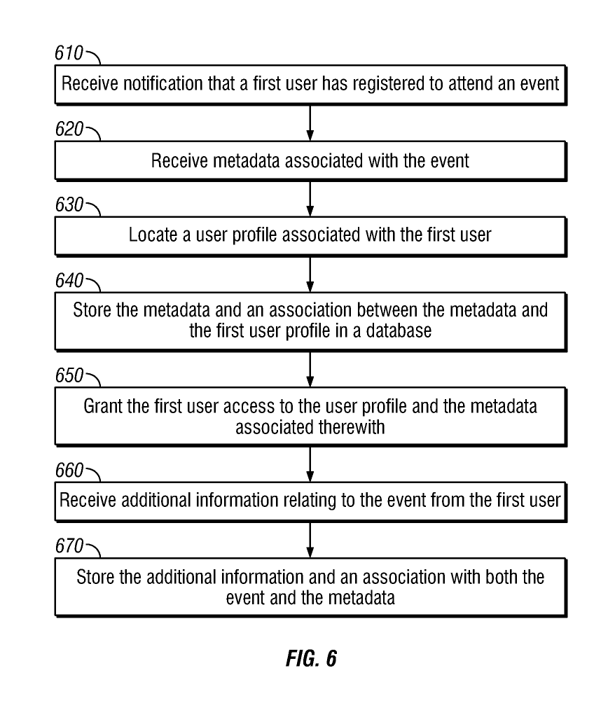

As described above, the functionality of the event memorabilia system has been described as a cloud-based service. In some implementations, however, some or all of the functionality of the event memorabilia system may be an application located on a client device such as a desktop computer, a mobile communication device, an entertainment appliance or game console and the like. FIG. 6 is a flowchart showing one example of a method for storing event memorabilia. The method, which in some implementations is performed by a cloud-based service, includes receiving over a wide-area network at 610 notification that a first user has registered to attend an event. Metadata associated with the event is also received over the wide-area network at 620. A user profile associated with the first user is located at 630. The metadata and an association between the metadata and the first user profile are stored in a database at 640. The first user is granted access to the user profile and the metadata associated therewith at 650. At some later time additional information (e.g., details of the event as experienced by the first user) relating to the event may be received at 660 from the first user over the wide-area network. The additional information and an association with both the event and the metadata associated with the event are stored at 670. In this way the user profile, the metadata and the additional information is searchable by the first user.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for storing event memorabilia, comprising:
receiving over a wide-area network notification that a first user has registered to attend an event;
receiving over the wide-area network metadata associated with the event;
locating a user profile associated with the first user;
storing the metadata and an association between the metadata and the first user profile in a database;
granting the first user access to the user profile and the metadata associated therewith.

2. The method of claim 1 further comprising obtaining the metadata from a service provider associated with the event.

3. The method of claim 1 further comprising, in response to a request from the first user, presenting a list of other users who have registered to attend the event.

4. The method of claim 3 further comprising presenting the user with a link to contact at least one of the other users who have registered to attend the event.

5. The method of claim 4 in which the link links to a web page of the other user on a social networking site.

6. The method of claim 1 further comprising:
receiving from the first user over the wide-area network additional information relating to the event; and
storing the additional information and association with the event and the metadata associated with the event such that the user profile, the metadata and the additional information is searchable by the first user.

7. The method of claim 6 in which the additional information chides details of the event as experienced by the first user.

8. The method of claim 1 further comprising:
receiving from second user a request to access the user profile, the metadata and the additional information associated therewith;
granting the second user access to the user profile, the metadata and the additional information associated therewith if the second user satisfies one or more conditions specified by the first user.

9. The method of claim 1 further comprising presenting the first user with recommendations of upcoming events based at least in part on the user profile and the list of events the user has attended or will attend.

10. The method of claim 1 further comprising, in response to a request from the first user, presenting a schedule of other events which the first user has attended or will attend.

11. The method of claim 1 further comprising establishing the user profile for the first user based at least on part on information provided by the first user, said information including a link to a second user profile for the first user which is maintained by a social networking service.

12. The method of claim 1 in which receiving the notification comprises automatically receiving the notification when a ticket or other proof of admission becomes electronically linked to the first user.

13. An event memorabilia system, comprising:
a server having a network interface for establishing communication over a wide-area network;
a user profile module configured to maintain user profiles and a history of events that users associated with the user profiles have attended or have scheduled to attend;
a metadata engine configured to acquire and store metadata associated with a plurality of events maintained in the history of events associated with the user profiles; and
a search engine responsive to user requests received over the wide-area network, said search engine allowing user to search their respective user profiles and the metadata associated with their respective user profiles.

14. The event memorabilia system of claim 13 further comprising a recommendations engine for recommending upcoming events to users based at least in part on their respective user profiles and the metadata associated with respective user profiles.

15. The event memorabilia system of claim 13 in which the user profile module is further configured to receive and store details of the events as experienced by the respective users associated with the respective user profiles.

16. One or more computer-readable storage media containing instructions which, when executed by one or more processors disposed in a computing device, perform a method comprising:
sending a notification over a wide-area network indicating that a first user has registered to attend a specified event such that the specified event is associated with a user profile for the first user;
sending over the wide-area network additional details of the specified event as experienced by the user;
sending a first search request requesting metadata associated with a previously-attended event attended by the user and associated with the user profile for the first user, said metadata being obtained from a service provider associated with the previously-attended event; and
receiving search results in response to the first search request.

17. The one or more computer-readable storage media of claim 16 further comprising sending a second request requesting an identity of one or more other users who have attended the previously attended event; and
receiving search results in response to the second search request.

18. The one or more computer-readable storage media of claim 17 in which the search results include a link to contact at least of the one or more other users.

19. The one or more computer-readable storage media of claim 18 in which said link directs the first user to a social networking site.

20. The one or more computer-readable storage media of claim 16 in which sending the notification comprises causing the notification to be sent when a ticket or other proof of admission becomes electronically linked to the first user.
